(19) United States
(12) Patent Application Publication
(10) Pub. No.: US 2003/0096689 A1
(43) Pub. Date: May 22, 2003

(54) Folding unit with at least one folding-roller load and folding machine having the folding unit

(76) Inventor: Hatto Hechler, Stuttgart (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/302,215

(22) Filed: Nov. 22, 2002

(30) Foreign Application Priority Data
Nov. 22, 2001 (DE) 101 57 252.2

(51) Int. Cl. B31F 1/10

(52) U.S. Cl. 493/424

(57) ABSTRACT

A folding unit includes a plurality of folding rollers mounted and loaded at ends thereof. A load element having a nonlinear expansion-force characteristic is provided at least at one of the folding rollers for loading. A folding machine includes the folding unit.

### BACKGROUND OF THE INVENTION

### FIELD OF THE INVENTION

The invention relates to a folding unit having at least one folding roller mounted and loaded at ends thereof. The invention also relates to a folding machine having the folding unit.

In folders and folding machines, distances at which the folding rollers are spaced from one another must be set equal to the thickness or to a multiple of the thickness of the folded product, in accordance with the desired type of fold and the papers to be processed. For that purpose, devices have already become known heretofore, with the aid of which folding gap widths can be set in a folding unit and in an entire folder. To this end, for example, German Utility Model DE 70 26 132 U1 discloses a device, with the aid of which, due to inserting a number of sample strips of the flat product to be processed, the spacing of the folding roller can be set reproducibly to one or more times the thickness of the flat product to be processed. That setting can be improved even further by an additional fine correction. During the operation of the folding machine, a sheet passing through and an already folded product, respectively, then force the rollers farther apart counter to a spring loading. A folding roller spring-loaded in that manner is disclosed, for example, in Published European Patent Application EP 511 488 A1, corresponding to U.S. Pat. No. 5,242,364. However, a disadvantage of such spring-loaded folding rollers is that the steel springs which are used are the same for all stations and operating ranges and, therefore, the spring constants thereof are also the same. Accordingly, adapting the spring force to the actual requirements at the respective pair of folding rollers is therefore possible only by increasing the prestressing of the spring or by replacing the spring by another spring with a different spring constant. In any case, that is possible only by exerting an increased expenditure and effort in terms of setting and time.

### SUMMARY OF THE INVENTION

It is accordingly an object of the invention to provide a folding unit with a folding-roller load or loading and a folding machine having the folding unit, which overcome the hereinafore-mentioned disadvantages of the heretofore-known devices of this general type and with the aid of which a rapid adaptation of a restoring force bearing on the folding-roller pair can be carried out in accordance with respective paper requirements.

With the foregoing and other objects in view, there is provided, in accordance with the invention, a folding unit, comprising a plurality of folding rollers mounted and loaded at respective ends thereof. A load or loading element having a nonlinear expansion-force characteristic is provided on the at least one folding roller, for loading at least one of the folding rollers.

In accordance with another feature of the invention, the load element includes an elastomeric body. A penetration element has a curved face for clamping the elastomeric body.

In accordance with a further feature of the invention, the penetration element is a conical penetration element.

In accordance with an added feature of the invention, the elastomeric body is formed of a natural rubber, a styrene-butadiene rubber or another reversibly deformable rubber.

In accordance with an additional feature of the invention, the folding unit further includes a flat plate for supporting the elastomeric body on one side thereof, and a conical penetration element for supporting the elastomeric body on another side thereof. The conical penetration element penetrates into the mass of the elastomeric body in an unloaded condition thereof.

In accordance with yet another feature of the invention, the load element is a pneumatic expansion element.

In accordance with yet a further feature of the invention, the pneumatic expansion element has a pneumatic annular diaphragm or a bellows cylinder.

In accordance with yet an added feature of the invention, the folding unit further includes a pressure line connected to the pneumatic expansion element supplying pressure thereto.

In accordance with yet an additional feature of the invention, the pressure supplied to said pneumatic expansion element is by compressed air.

In accordance with still another feature of the invention, the folding unit further includes an operating panel via which the pressure is to be set in the pneumatic expansion element.

With the objects of the invention in view, there is also provided a folding machine, comprising at least one folding unit including a plurality of folding rollers mounted and loaded at respective ends thereof. A load element having a nonlinear expansion-force characteristic is provided on the at least one folding roller, for loading at least one of the folding rollers.

According to the invention, therefore, a load element is provided on at least one of the folding rollers. This load element exhibits a nonlinear deflection-force characteristic. Such a configuration of the load element ensures that, in the event of high deflection of the folding rollers relative to one another, the restoring force rises disproportionately and therefore secure transport is assured, even in the case of thick papers. At the same time, when thin papers pass through the nip, assurance is provided that the force acting upon the paper is kept so low that, although the paper is transported securely, marking of the paper by the folding rollers is prevented.

These nonlinear loading elements may be implemented in many ways. For example, the load element can be formed as an elastomeric body, on one side face of which a plate and on the other side face of which a conical penetration element are provided. In particular, by providing the conical penetration element, both the course of the nonlinear deflection-force characteristic and the prestressing of the elastomeric body can be set.

In addition, it is also possible to provide a so-called pneumatic expansion element as a load element. In this regard, for example, a pneumatic annular diaphragm or a bellows cylinder can be used, which is provided with a pressure line. It is then, in turn, possible for the prestressing of the load element and the nonlinear deflection-force characteristic to be set for the respective task to be performed by the folding-roller pair, through the pressure line.

Of course, other load elements which exhibit a nonlinear deflection-force characteristic, such as fluid pads, can also be used.

In every case, the use of the load element according to the invention ensures that lightweight papers will be folded with very low forces, so that static loading is reduced. At the same time, for thicker papers, assurance is provided that, as a result of the greater deflection which then arises, the restoring force in the folding-roller nips increases, so that these papers can also be guided securely.

The load element according to the invention can be used both in the folding rollers of a pocket folding device and a blade folding device or in a so-called combined machine, which has both pocket and blade folding units. It is therefore possible, via the combination with an automatic or mechanical presetting system, to vary the folding loading force to be expected for the respective station within wide limits and, by using the load element with a nonlinear deflection-force characteristic, to optimize the force even for different paper thicknesses.

Other features which are considered as characteristic for the invention are set forth in the appended claims.

Although the invention is illustrated and described herein as embodied in a folding unit with a folding-roller load and a folding machine having the folding unit, it is nevertheless not intended to be limited to the details shown.

That is because various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, elevational view of a pocket folding unit having a pneumatic expansion element as a load element;

FIG. 2 is a view similar to that of FIG. 1, showing a pocket folding unit having an elastomeric body as the load element; and

FIG. 3 is a plot diagram of force against deflection showing a portion of the course of a deflection-force line.

### DESCRIPTION OF THE PREFERRED EMBODIMENTS

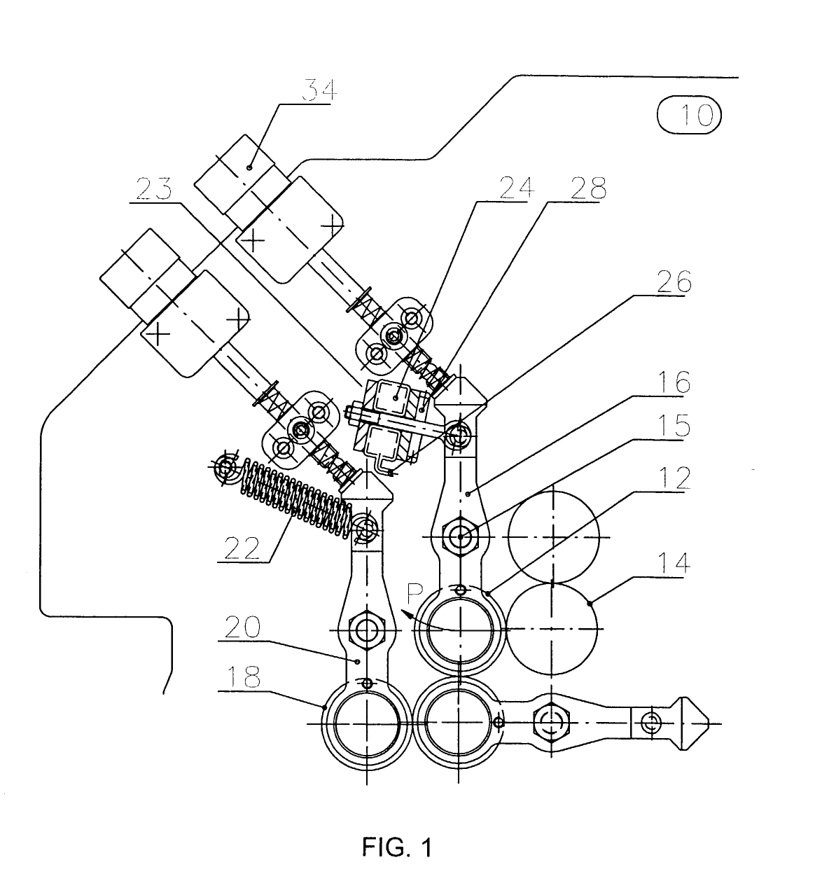

Referring now to the figures of the drawings in detail and first, particularly, to FIG. 1 thereof, there is seen a pneumatic expansion element serving as a load element 23, forming part of a folding unit 10, wherein folding rollers 12 and 14 are provided. The folding roller 12 is fitted to an arm 16 so as to be revolvable about a point 15. The arm 16 is movable about the point 15 in the direction of the curved arrow P when a paper to be folded passes between the folding rollers 12 and 14. In a conventional manner, a reversal or restoration, as shown by the use of the folding roller 18 and the arm 20, is assured by a spring 22, the restoring force of which is set permanently either via the restoring force of the selected spring or via the adjustable stress condition thereof. According to the invention, this spring is then replaced by a load element formed as a pneumatic expansion element 24. For example, the pneumatic expansion element can be constructed as a pneumatic annular diaphragm or bellows cylinder. This diaphragm or this bellows cylinder is pressurized in order to produce the restoring action, which can be achieved by providing a pressure line 26 via which the pneumatic expansion elements 24 can be acted upon by excess or positive pressure, in particular, can be filled with air pressure. A piston compressor incorporated in the machine can be provided for filling the expansion elements 24 with the air pressure. Alternatively, a supply of compressed air via a supply independent of the folder, for example, a service or main air supply is also possible. The strength or power of the compressed air is set via an operation panel, which is either integrated into the main operating panel or is fitted to each folding unit 10 as an individual operating panel. It is thereby possible, by the different pressure setting, to set and cause each individual pair of folding rollers to respond directly to the forthcoming folding task. The pneumatic expansion element 24 is fixed to the roller frame with the aid of a fastening element, in particular a plate 28, so that the opposing pressure on the arm 16, in the event of a deflection of the arm 16 in the direction of the arrow P, can act upon the arm 16.

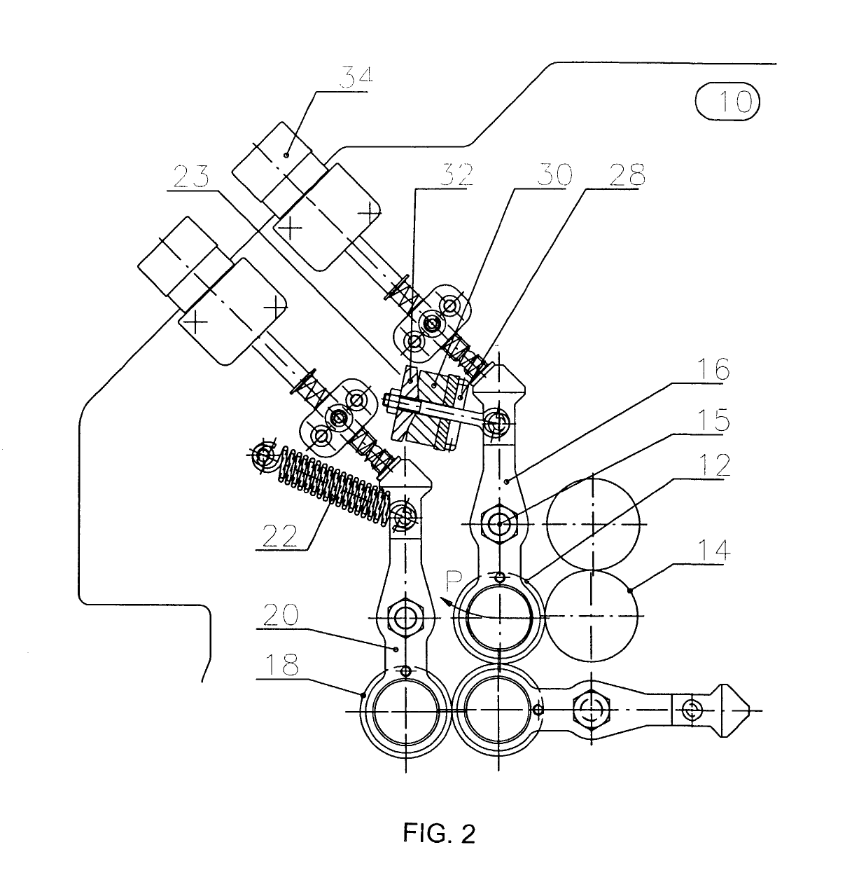

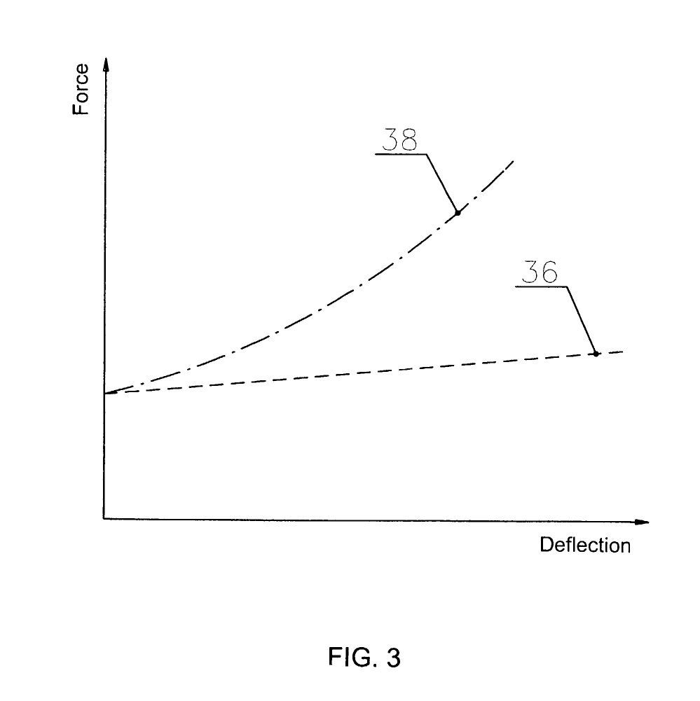

FIG. 2, wherein an elastomeric body is provided as the load element 23, shows an alternative configuration of the invention, wherein a pair of folding rollers 12 and 14 are again provided in a folding unit 10. The folding roller 12 is again fixed to an arm 16, which is moved around the point 15 in the direction of the arrow P as a paper passes through the nip between the folding rollers 12 and 14. The arm 16 is again coupled to the load element 23 which, in the embodiment of FIG. 2, is constructed with an elastomeric body 30. This elastomeric body 30 is clamped between the plate 28, which is permanently connected to the roller frame, and a penetration element 32. The penetration element 32 has a curved face and is preferably conical. The penetration depth thereof into the mass of the elastomeric body 30 can be set via the presetting element 34. The presetting element 34 at the same time determines the nip in the initial state. Therewith, the prestressing of the elastomeric body 30 can be regulated at the same time. Elastomeric bodies are considered to be all bodies having a nonlinear restoring force, as explained in greater detail hereinafter in connection with FIG. 3. The setting of the restoring force is, in this case, also affected by the type of conicity of the conical penetration element 32. Furthermore, as the penetration depth increases, the nonlinear spring characteristic, which is present in any case in the elastomeric body 30, rises. This has the immediate effect that the folding-roller prestressing rises considerably more sharply when something thicker is put underneath the presetting element 34 than when something thinner is put underneath it.

In FIG. 3, with the aid of arbitrary units for the force and for the deflection, the mode of action of the load elements 23 for the use of a spring by a curve 36 and for the use of a load element 23 with a nonlinear expansion-force characteristic by a curve 38 is shown qualitatively. Because the two load elements 23, respectively, described with respect to FIGS. 1 and 2 each have a nonlinear expansion-force characteristic, the use of these two elements has a significant effect upon the presetting which is performed with the aid of the presetting element 34. The folding load force, which in principle is then set by inserting sample papers into the presetting element, in cooperation with the nonlinear load element 23, causes the folding-roller prestressing to increase considerably more sharply, respectively, when something thicker is put underneath the presetting element than when something thinner is placed underneath, while, in the case of steel springs, the folding-roller prestressing rises only very slightly because of the lower deflection. These relationships are, respectively, reproduced qualitatively by the curves 36 for the springs heretofore known from the state of the prior art, and the nonlinear loading elements 38 according to the invention. This is particularly advantageous for heavy sheets, wherein the spring force is often barely sufficient for assuring secure retention between the folding rollers. In the case of lightweight papers, on the other hand, the folding rollers are deflected only slightly, so that folding can be carried out with a lower force. Therefore, without requiring an additional setting operation, the static loading is automatically reduced. The fundamental prestressing is able to be set quite simply in the case of the elements according to the invention, only the air pressure having to be adapted in accordance with the requirements in the system to which compressed air is applied. When an elastomeric body is used which, for example, may be formed from natural rubber, styrene-butadiene rubber or some other reversibly deformable rubber, the prestressing can be influenced by the intensity of the penetration of the penetration element 32 or by the shape thereof.

Furthermore, the loading elements according to the invention offer the advantage that any tolerances occurring in folding rollers can be compensated for individually by the prestressing of the load element. A measure of this type can be incorporated, as well, in particular in the folding-roller presetting, it being possible for the folding-roller load to be incorporated in the automatic presetting, for example via electromotive pressure-reducing valves.

The load elements can be provided on both sides of the folding unit, i.e., thus, on the drive and operating sides. Because the elements on both sides are then adjustable individually with respect to the restoring force thereof, forces which result from the drive can also be compensated for so that the folding rollers are loaded uniformly on both sides.

In addition to the use of the adjustable load elements with a nonlinear expansion-force characteristic on folding rollers, these elements can also be used on other processing elements of the folding unit 10. In particular, if the load elements according to the invention are used on a knife shaft, the cutting forces may be made adjustable.

I claim:

1. A folding unit, comprising:
a plurality of folding rollers mounted and loaded at ends thereof; and
a load element having a nonlinear expansion-force characteristic disposed at least at one of said folding rollers for loading.

2. The folding unit according to claim 1, wherein said load element is an elastomeric body, and a penetration element having a curved face serves for clamping said elastomeric body.

3. The folding unit according to claim 2, wherein said penetration element is a conical penetration element.

4. The folding unit according to claim 1, wherein said elastomeric body is formed of a material selected from the group consisting of natural rubber, a styrene-butadiene rubber, and another reversibly deformable rubber.

5. The folding unit according to claim 2, further comprising a flat plate for supporting said elastomeric body on one side thereof, and a conical penetration element for supporting said elastomeric body on another side thereof, said conical penetration element penetrating into the mass of said elastomeric body in an unloaded condition thereof.

6. The folding unit according to claim 1, wherein said load element is a pneumatic expansion element.

7. The folding unit according to claim 6, wherein said pneumatic expansion element has a pneumatic annular diaphragm.

8. The folding unit according to claim 6, wherein said pneumatic expansion element has a bellows cylinder.

9. The folding unit according to claim 5, further comprising a pressure line connected to said pneumatic expansion element and supplying pressure thereto.

10. The folding unit according to claim 9, wherein said pressure supplied to said pneumatic expansion element is by compressed air.

11. The folding unit according to claim 9, further comprising an operating panel for setting said pressure in said pneumatic expansion element.

12. A folding machine, comprising at least one folding unit including:
a plurality of folding rollers mounted and loaded at ends thereof; and
a load element having a nonlinear expansion-force characteristic provided at least at one of said folding rollers for loading.
